(19) United States
(12) Patent Application Publication
(10) Pub. No.: US 2005/0030858 A1
(43) Pub. Date: Feb. 10, 2005

(54) METHOD FOR PROTECTING A PICKUP HEAD FROM TEMPERATURE VARIATION

(76) Inventors: Chien-Li Hung, Taipei City (TW); Shih-Hung Chang, Taipei City (TW); Tao-Yen Wei, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/710,618

(22) Filed: Jul. 25, 2004

(30) Foreign Application Priority Data
Aug. 8, 2003 (TW) 092121923

(51) Int. Cl. G11B 5/09

(52) U.S. Cl. 369/47.41; 369/47.44

(57) ABSTRACT

The invention uses a thermistor to detect the ambient temperature of a pickup head. When the temperature is higher than a first predetermined temperature, the speed of the spindle motor of the optical disk drive is decreased for eliminating the heat produced from the power driver and actuator. In this way, the pickup head can be protected from burning out or suffering heat-related damage.

### BACKGROUND OF INVENTION

1. Field of the Invention

The present invention relates to a method for protecting an optical disk drive pickup head, and more particularly, to a method for protecting a pickup head from temperature variation.

2. Description of the Prior Art

The laser diode of an optical pickup head is a light source for accessing an optical disk. When the optical disk drive is working, a control current flows to an actuator of the optical pickup head to make the coils of the actuator generate magnetic force. Therefore, the lens moves due to the magnetic force for focusing and searching tracks of the disk.

Generally speaking, when an optical disk drive is working, the main factor contributing to temperature increase is the control current of a power driver flowing to the actuator. When the spindle motor of the optical disk drive rotates at high speed, the power driver must provide larger current to drive the spindle motor. Moreover, the servo gain must be increased to enlarge the control current flowing to the actuator.

In other words, when the spindle motor of the optical disk drive rotates at high speed, the currents flowing to the power driver and the actuator are both high. Therefore, the coils of the actuator and the power driver produce a large amount of heat. This causes the temperature inside the optical disk drive to increase continuously. After the optical disk drive accesses data for a long time, the elevated temperature inside the optical disk drive can lead to burning the laser diode, cracking the coated lens of the optical pickup head, melting of the lens, or burning out the actuator.

### SUMMARY OF INVENTION

It is therefore a primary objective of the claimed invention to provide a method for protecting a pickup head from temperature variation to avoid damaging the optical pickup head and its elements due to increased temperature of the optical pickup head.

The present invention provides a method for protecting a pickup head from temperature variation. The method comprises detecting a temperature of the optical pickup head when the spindle motor rotates at a first speed, and controlling the spindle motor to rotate at a second speed if the temperature of the optical pickup head is over a first predetermined temperature, wherein the second speed is slower than the first speed.

The present invention provides a method for protecting a pickup head from temperature variation. The method comprises detecting a temperature of the optical pickup head when the spindle motor of the optical disk drive rotates, and reducing the speed of the spindle motor if the temperature of the optical pickup head increases to a first predetermined temperature.

Moreover, the present invention provides a method for protecting a pickup head from temperature variation. The method comprises detecting a temperature of the optical pickup head when the spindle motor of the optical disk drive rotates, and reducing the speed of the spindle motor if the temperature of the optical pickup head decreases to a first predetermined temperature.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a state diagram of a first embodiment according to the present invention.

FIG. 2 is a state diagram of a second embodiment according to the present invention.

### DETAILED DESCRIPTION

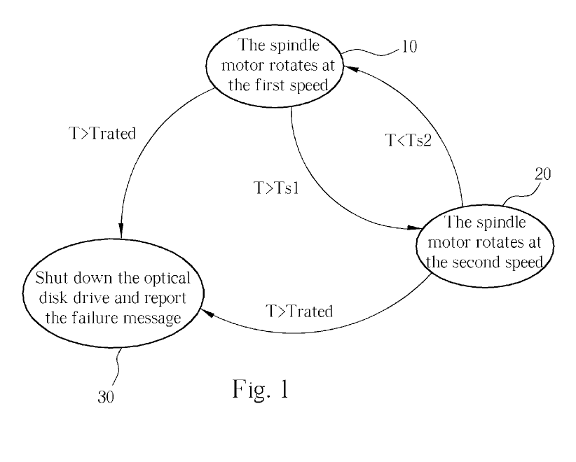

Generally, a thermistor is embedded in the optical pickup head of the optical disk drive. Therefore, the present invention utilizes the thermistor to detect the temperature of the optical pickup head and avoid overheating the optical pickup head according to the detected temperature. Please refer to FIG. 1. FIG. 1 is a state diagram of the first embodiment based on the present invention.

First, there are at least three states in the optical disk drive: a state 10 in which the spindle motor rotates at a first speed, a state 20 in which the spindle motor rotates at a second speed, and a state 30 in which the spindle motor is shut down and a failure message is reported, wherein the first speed is faster than the second speed and the first speed is the speed at which the optical pickup head regularly accesses data.

In the state 10, the thermistor detects the temperature T of the optical pickup head while the spindle motor rotates at high speed (such as 48× or 52×). If the temperature T of the optical pickup head is higher than a first predetermined temperature Ts1, state 20 is entered to let the spindle motor rotate at low speed (such as 24× or 32×). If the temperature T of the optical pickup head is higher than a rated operating temperature Trated, state 30 is entered, where the spindle motor is shut down and a failure message is reported.

In the state 20, the thermistor detects the temperature T of the optical pickup head while the spindle motor rotates at low speed (such as 24× or 32×). If the temperature T of the optical pickup head is lower than a second predetermined temperature Ts2, state 10 is entered to let the spindle motor rotate at high speed (such as 48× or 52×). If the temperature T of the optical pickup head is higher than the rated operating temperature Trated, state 30 is entered, where the spindle motor is shut down and a failure message is reported.

In the first embodiment of the present invention, the rated operating temperature Trated of the optical pickup head is 60 C; the first predetermined temperature Ts1 is 55 C; and the second predetermined temperature Ts2 is 50 C. Due to the present invention continuously detecting the temperature T of the optical pickup head, before the temperature T increases to the rated operating temperature Trated, when the temperature T increases to the first predetermined temperature Ts1, the speed of the spindle motor is first reduced. Therefore, the servo gain of the actuator can be reduced and the control current flowing to the coils also decreases to reduce the heat produced by the coils. Similarly, the current output from the power driver is also reduced, thus the generation of excess heat can be eliminated efficiently.

When the spindle motor rotates at low speed, the temperature T of the optical pickup head is continuously detected. If the temperature T of the optical pickup head is between the first predetermined temperature Ts1 and the rated operating temperature Trated, the spindle motor still rotates at low speed (such as 24× or 32×). If the temperature T of the optical pickup head is lower than the second temperature Ts2, the speed of the spindle motor is increased to high speed (such as 48× or 52×). If the temperature T of the optical pickup head increases to the rated temperature Trated, the spindle motor is shut down and a failure message is reported. Therefore, the present invention can efficiently prevent the temperature of the optical pickup head increasing so as to protect the optical pickup head.

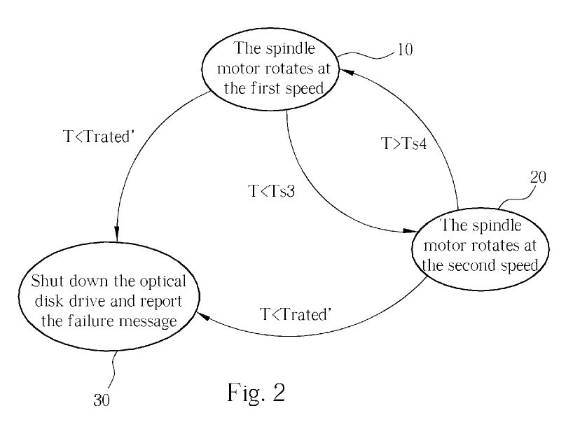

Please refer to FIG. 2. FIG. 2 is a state diagram of the second embodiment according to the present invention. Generally, the optical pickup head also has a lower limit temperature Trated. Thus, the present invention is also suitable to be implemented for a low temperature condition.

First, there are at least three states in the optical disk drive: a state 10 in which the spindle motor rotates at the first speed, a state 20 in which the spindle motor rotates at the second speed, and a state 30 in which the spindle motor is shut down and a failure message is reported.

In the state 10, the thermistor detects the temperature T of the optical pickup head while the spindle motor rotates at high speed (such as 48× or 52×). If the temperature T of the optical pickup head is lower than a third predetermined temperature Ts3, state 20 is entered to let the spindle motor rotate at low speed (such as 24× or 32×). If the temperature T of the optical pickup head is lower than the lower limit temperature Trated, state 30 is entered, where the spindle motor is shut down and a failure message is reported.

In the state 20, the thermistor detects the temperature T of the optical pickup head while the spindle motor rotates at low speed (such as 24× or 32×). If the temperature T of the optical pickup head is higher than a fourth predetermined temperature Ts4, state 10 is entered to let the spindle motor rotate at high speed (such as 48× or 52×). If the temperature T of the optical pickup head is lower than the lower limit temperature Trated, state 30 is entered, where the spindle motor is shut down and a failure message is reported.

In the second embodiment of the present invention, the lower limit temperature Trated of the optical pickup head is 5 C; the third predetermined temperature Ts3 is 10 C; and the fourth predetermined temperature Ts4 is 15 C

In addition, the first (55 C), second (50 C), third (10 C), and fourth (15 C) predetermined temperatures in the embodiments of the present invention are examples. The predetermined temperatures can be set according to different requirements. The present invention does not limit the first, second, third, and fourth predetermined temperatures.

Compared to the prior art, the present invention provides a method for protecting the optical pickup head from temperature variation. The present invention utilizes a thermistor to continuously detect the temperature of the optical pickup head. If the temperature of the optical pickup head is over the first predetermined temperature, the current output from the power driver and the servo gain of the actuator are reduced to slow down the spindle motor of the optical disk drive. Thus, the temperature of the optical pickup head can be efficiently decreased since the speed of the spindle motor is decreased. In addition, if the temperature of the optical pickup head is lower than the third predetermined temperature, the current output from the power driver and the servo gain of the actuator are reduced so as to avoid potential drawbacks when the optical pickup head records a CD or VCD. For instance, the playback of a CD or VCD is poor if the recording quality of the CD or VCD is not good enough. Additionally, the present invention can efficiently avoid the temperature of the optical pickup head increasing or decreasing continuously, which causes the optical disk drive not to operate smoothly.

Those skilled in the art will readily observe that numerous modifications and alterations of the device may be made while retaining the teachings of the invention. Accordingly, the above disclosure should be construed as limited only by the metes and bounds of the appended claims.

1. A method for protecting an optical pickup head from temperature variation comprising:
detecting a temperature of the optical pickup head when a spindle motor rotates at a first speed; and
controlling the spindle motor to rotate at a second speed if the temperature of the optical pickup is over a first predetermined temperature;
wherein the second speed is slower than the first speed.

2. The method of claim 1 wherein the temperature of the optical pickup head is detected by a thermistor.

3. The method of claim 1 wherein if the temperature of the optical pickup head increases to a rated operating temperature, the spindle motor is shut down.

4. The method of claim 1 further comprising when the spindle motor rotates at the second speed, controlling the spindle motor to rotate at the first speed if the temperature of the optical pickup head is lower than a second predetermined temperature.

5. The method of claim 4 wherein the first predetermined temperature is higher than the second predetermined temperature.

6. A method for protecting an optical pickup head from temperature variation comprising:
detecting a temperature of the optical pickup head when a spindle motor of an optical disk drive rotates; and
reducing the speed of the spindle motor if the temperature of the optical pickup increases to a first predetermined temperature.

7. The method of claim 6 wherein the temperature of the optical pickup head is detected by a thermistor.

8. The method of claim 6 wherein if the temperature of the optical pickup head increases to a rated operating temperature, the spindle motor is shut down.

9. The method of claim 6 further comprising when the spindle motor rotates at low speed, increasing the speed of the spindle motor if the temperature of the optical pickup head is lower than a second predetermined temperature.

10. The method of claim 9 wherein the first predetermined temperature is higher than the second predetermined temperature.

11. A method for protecting an optical pickup head from temperature variation comprising:
detecting a temperature of the optical pickup head when a spindle motor of an optical disk drive rotates; and
reducing the speed of the spindle motor if the temperature of the optical pickup decreases to a first predetermined temperature.

12. The method of claim 11 wherein the temperature of the optical pickup head is detected by a thermistor.

13. The method of claim 11 wherein if the temperature of the optical pickup head decreases to a rated operating temperature, the spindle motor is shut down.

14. The method of claim 11 further comprising when the spindle motor rotates at low speed, increasing the speed of the spindle motor if the temperature of the optical pickup head is higher than a second predetermined temperature.

15. The method of claim 14 wherein the first predetermined temperature is lower than the second predetermined temperature.
